(19) United States
(12) Patent Application Publication
(10) Pub. No.: US 2023/0056889 A1
(43) Pub. Date: Feb. 23, 2023

(54) Component Arrangement For Gravitational Water Desalination

(71) Applicant: Enock N. Segawa, Grand Rapids, MI (US)

(72) Inventor: Enock N. Segawa, Grand Rapids, MI (US)

(21) Appl. No.: 17/363,885

(22) Filed: Jun. 30, 2021

(51) Int. Cl. B01D 61/10; B01D 61/02; B01D 61/08; B01D 61/12; C02F 1/44

(52) U.S. Cl. CPC B01D 61/10; B01D 61/08; B01D 61/12; B01D 61/025; C02F 1/441; B01D 2313/243; C02F 2103/08

(57) ABSTRACT

High energy consumption and the negative impacts of hyper saline brine are the two biggest hurdles to a widespread adoption of seawater desalination. Taking advantage of the principal that fluid pressure increases in direct proportion to depth, this invention reduces energy consumption by relocating the process of reverse osmosis at depths where the weight of the water produces the pressure required to drive the reverse osmosis process thereby eliminating the high costs normally associated with raising intake pressure and by simply varying pumping rates, the brine stream can be pre-diluted to levels slightly above the original thereby reducing environmental impact. The simplicity of the design also reduces the costs of building and installation thereby making it likely that seawater desalination will proliferate around the world.

### CROSS-REFERENCE TO RELATED APPLICATIONS

This application claims the benefit of provisional application ser. No 63/046,446 filed on Jun. 30, 2020, by the present inventor.

### TECHNICAL FIELD

In general, this invention relates to water desalination and more particularly to a component arrangement that allows the generation of the pressure required to drive the process of reverse osmosis to be partly or fully due to gravity.

### BACKGROUND

It’s a well-known fact that water scarcity is increasingly becoming problem all over the planet. Even though 70% the planet is covered with water, only 2% is fresh and the rest is salty undrinkable water. Currently, about a fourth of the world population is without easy access to clean drinking water and as world population grows, this water scarcity problem is only projected to get worse. By some estimates, more than half of the world population will live in water stressed communities by 2050. The only alternative to supplementing the available fresh water resources is either thermal or reverse osmosis of sea water desalination. Besides the fact that they both require high capital investments upfront, the ongoing overhead cost of running either of these is very high and that’s because both of these desalination methods are highly energy intensive. That’s why up till now, water desalination has been available only to countries or communities with enough resources to pay for the initial investment costs and the high overhead of running highly energy intensive desalination plants. This automatically eliminates developing countries and poor communities which happen to be located in arid climates.

Therefore, there is a need for a cheaper and much more efficient alternative method of removing salt from water thereby making desalination a viable option for communities in arid regions and the developing world especially those with access to sea or brackish water.

Serendipitously the arrangement of this invention provides for an ecofriendly way of disposing hyper saline brine which is an environmental problem that all desalination plants have to deal with.

### SUMMARY

This invention operates on a well known principle in fluid dynamics that pressure is directly proportional to depth. Herein, the process of reverse osmosis lowered to such depths that the weight of the water produces the pressure required to drive the reverse osmosis. Traditionally the energy required to run the process of reverse osmosis broadly falls in two categories 1^{st} pumping the water into and or out of the plant, 2^{nd} pressurizing the water to force it thru the membrane. Most of the energy consumption is towards the later and that’s what this invention is seeks to reduce either in part of fully.

Advantages
Reducing the cost of building/constructing a water desalination plant
Minimizing the cost of running the process of reverse osmosis
Making water desalination more of a viable option to developing countries and communities in arid desert areas
Reducing the greenhouse gases, the byproducts of the highly energy intensive process of water desalination plants
Reducing the footprint of water desalination plants
Providing a new process of water purification to city and municipality water treatment plants
Cutting the cost of water treatment for city and municipality governments
Providing a cheap means of augmenting supplies for agriculture and other water intensive industries
Providing a solution to reducing the salinity of brine by simply adjusting flow rates Other objects and advantages will become obvious in the process of reading this disclosure and practicing the examples herein. It is also worth noting that this disclosure only mentions information that relates to the process of reverse osmosis. Other information like pre-filtration and post treatment are left out as they are well documented in prior art.

### BRIEF DESCRIPTIONS OF DRAWINGS

FIG. 1 schematic of arrangement

FIG. 2 A more detailed view of arrangement without the pumps, interconnections and computer control module

FIG. 3A A more detailed view of the lower end of arrangement

FIG. 3B A variation of FIG. 3A where tube 2 has a opening 32

### DETAILED DESCRIPTION

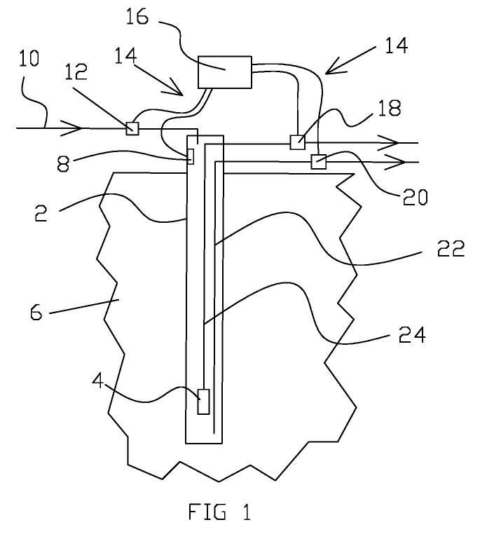

FIG. 1 shows an exemplary set up of arrangement. Vertical tube 2 is installed into the ground 6. Pump 12 supplies salt water from filter or reservoir (not shown) to Tube 2 through water line 10. From line 10 water goes through salt separation membrane assembly 4 and continues through water line 24 via Pump 18. The remaining brine is evacuated by pump 20 through waterline 22. Also shown in here is computer control module 16 in communication with water level sensor 8 and water pumps 12, 18 and 20 through wires 14. In order to reduce the salinity of the rejected water (if so desired), water line 22 may be pre-diluted prior to disposal by calibrating computer control 16 to run pumps 12 and 20 at a higher flow rate than pump 18.

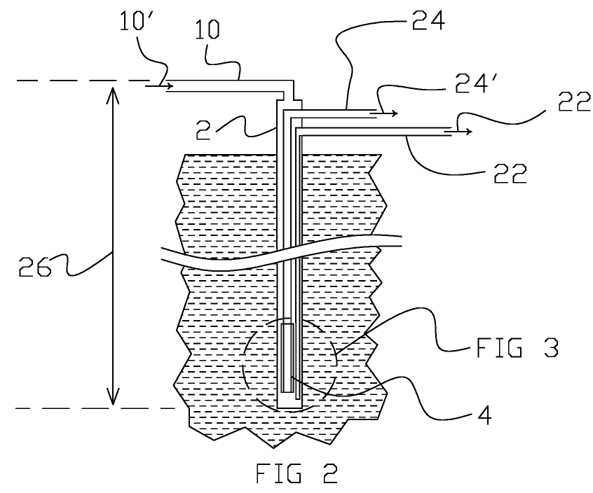

FIG. 2 shows more detailed look of the arrangement (pumps, wires, sensor and computer not shown). Water line 10 with salt water 10’ connected ant the top of water tube 2 installed in ground. Water 10’ fills up tube 2 via gravity. The pressure of the water at the bottom of tube 2 forces the water through membrane assembly 4. Normally it takes around 70 bar (1,000 psi) to force water through membrane assembly 4. To generate that amount of water pressure using gravity, the membrane assembly 4 must be at depth 26 which is around 723 meters, therefore water tube 2 is longer than 723 m deep in order to collect rejected brine. The Salt free water 24' after membrane assembly 4 flows through water line 24 either for further treatment or ready for use. The rejected brine 22’ flows through water line 22 for disposal.

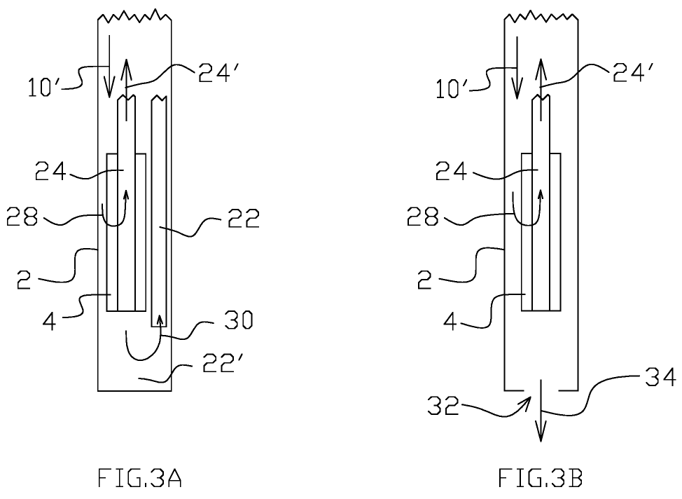

FIG. 3A is an even more detailed look at the bottom of the water tube 2. Salt water 10’comes in from the top and forced through membrane assembly 4 in direction 28. At that point salt-free water 24’ and continues through water line 24. The rejected brine 22’ collects at the very bottom of water tube 2 and sucked up by water line 22 as indicated by direction 30.

FIG. 3B is an offshore variation of FIG. 3A where the brine is disposed at the bottom of tune 2 in direction32 through opening 34.

What is claimed is:

1. A component arrangement system comprising:
(a) a vertically oriented bore and of substantial depth
(b) a multiplicity of water pumps in fluid communication with water passages
(c) a means to control the pumping rates of said pumps
(d) at least one of said water passages adapted to evacuate water from a substantially deep point in said bore
(e) at least one salt separation membrane assembly disposed at said depth and in fluid communication with at least one of said fluid passages
whereby the weight of the water serves as the source of the pressure needed to accomplish reverse osmosis.

2. The arrangement of claim 1 incorporated into an underground chamber large enough to house a desalination plant.

3. The arrangement of claim 1 wherein said bore is a rigid tube disposed at sea to allow for offshore application.

4. The arrangement of claim 1 wherein the brine concentration is prediluted by varying the pumping rates of said pumps.

5. The arrangement of claim 3 wherein the bottom end of said bore is in fluid communication with seawater.

6. The arrangement of claim 3 wherein a multiplicity of said tubes is spaced out at sea.
